(19) United States
(12) Patent Application Publication
(10) Pub. No.: US 2026/0274334 A1
(43) Pub. Date: Sep. 17, 2026

(54) REAL-TIME DAMPING CONTROL METHOD FOR ADVANCED DRIVING ASSISTANCE SYSTEM STEERING

(71) Applicant: GM Global Technology Operations LLC, Detroit, MI (US)

(72) Inventors: Amirreza Mirbeygi Moghaddam, Toronto (CA); Mehdi Abroshan, Waterloo (CA); Mohammadali Shahriari, Markham (CA); Hassan Askari, Thornhill (CA); Ashraf Abualfellat, Grand Blanc, MI (US)

(73) Assignee: GM Global Technology Operations LLC, Detroit, MI (US)

(21) Appl. No.: 19/079,200

(22) Filed: Mar. 13, 2025

(51) Int. Cl. B62D 6/00

(52) U.S. Cl. CPC B62D 6/002

(57) ABSTRACT

A computer-implemented method includes operating a motor of a steering system of a vehicle as the vehicle travels relative to a planned path to execute a first torque command. The first torque command causes the steering system of the vehicle to guide the vehicle toward the planned path. Responsive to operating the motor to execute the first torque command, and based on measured feedback from the vehicle, the method includes adjusting a parameter set of a feedforward control command function. Responsive to adjusting the parameter set of the feedforward control command function, the method includes generating a second torque command using the feedforward control command function having the adjusted parameter set. The method includes operating the motor of the steering system to execute the second torque command to cause the steering system of the vehicle to guide the vehicle toward the planned path.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to systems and methods for generating steering control commands for an advanced driving assistance system (ADAS) of a vehicle.

A typical ADAS may control steering of a vehicle based on feedback signals from the system. However, these systems may not learn and adapt to unmodeled uncertainties and environmental disturbances, resulting in inconsistent performance during transient responses. Moreover, these systems may share a common calibration across different vehicles and even across different vehicle platforms and, thus, may not adapt specifically to the equipped vehicle.

### SUMMARY

One aspect of the disclosure provides a computer-implemented method that, when executed on data processing hardware, causes the data processing hardware to perform operations. The operations include operating a motor of a steering system of a vehicle as the vehicle travels relative to a planned path to execute a first torque command. The first torque command causes the steering system of the vehicle to guide the vehicle toward the planned path. Responsive to operating the motor to execute the first torque command, and based on measured feedback from the vehicle, the operations include adjusting a parameter set of a feedforward control command function. Responsive to adjusting the parameter set of the feedforward control command function, the operations include generating a second torque command using the feedforward control command function having the adjusted parameter set. The operations include operating the motor of the steering system to execute the second torque command to cause the steering system of the vehicle to guide the vehicle toward the planned path.

Implementations of the disclosure may include one or more of the following optional features. In some implementations, the measured feedback includes a measured torque at the steering system of the vehicle. In other implementations, the measured feedback includes a determined steering angle of the steering system of the vehicle. In some examples, the first torque command is generated using the feedforward control command function prior to adjusting the parameter set. In some aspects, the feedforward control command function includes a learned model of the steering system of the vehicle. In further aspects, adjusting the parameter set of the feedforward control command function adjusts the learned model of the steering system of the vehicle. In some implementations, the feedforward control command function operates according to a first set of parameters based on the vehicle travelling at a first velocity and the feedforward control command function operates according to a second set of parameters different than the first set of parameters based on the vehicle travelling at a second velocity different than the first velocity.

Another aspect of the disclosure provides a system. The system includes memory hardware storing instructions that, when executed on data processing hardware in communication with the memory hardware, cause the data processing hardware to perform operations. The operations include operating a motor of a steering system of a vehicle as the vehicle travels relative to a planned path to execute a first torque command. The first torque command causes the steering system of the vehicle to guide the vehicle toward the planned path. Responsive to operating the motor to execute the first torque command, and based on measured feedback from the vehicle, the operations include adjusting a parameter set of a feedforward control command function. Responsive to adjusting the parameter set of the feedforward control command function, the operations include generating a second torque command using the feedforward control command function having the adjusted parameter set. The operations include operating the motor of the steering system to execute the second torque command to cause the steering system of the vehicle to guide the vehicle toward the planned path. This aspect may include one or more of the following optional features.

In some implementations, the measured feedback includes a measured torque at the steering system of the vehicle. In other implementations, the measured feedback includes a determined steering angle of the steering system of the vehicle. In some examples, the first torque command is generated using the feedforward control command function prior to adjusting the parameter set. In some aspects, the feedforward control command function includes a learned model of the steering system of the vehicle. In further aspects, adjusting the parameter set of the feedforward control command function adjusts the learned model of the steering system of the vehicle. In some implementations, the feedforward control command function operates according to a first set of parameters based on the vehicle travelling at a first velocity and the feedforward control command function operates according to a second set of parameters different than the first set of parameters based on the vehicle travelling at a second velocity different than the first velocity.

Yet another aspect of the disclosure provides a vehicle. The vehicle includes a steering system including a motor, and memory hardware. The memory hardware stores instructions that, when executed on data processing hardware in communication with the memory hardware, cause the data processing hardware to perform operations. The operations include operating the motor of the steering system as the vehicle travels relative to a planned path to execute a first torque command. The first torque command causes the steering system of the vehicle to guide the vehicle toward the planned path. Responsive to operating the motor to execute the first torque command, and based on measured feedback from the vehicle, the operations include adjusting a parameter set of a feedforward control command function. Responsive to adjusting the parameter set of the feedforward control command function, the operations include generating a second torque command using the feedforward control command function having the adjusted parameter set. The operations include operating the motor of the steering system to execute the second torque command to cause the steering system of the vehicle to guide the vehicle toward the planned path. This aspect may include one or more of the following optional features.

In some implementations, the measured feedback includes a measured torque at the steering system of the vehicle. In other implementations, the measured feedback includes a determined steering angle of the steering system of the vehicle. In some examples, the first torque command is generated using the feedforward control command function prior to adjusting the parameter set. In some aspects, the feedforward control command function includes a learned model of the steering system of the vehicle. In some implementations, the feedforward control command function operates according to a first set of parameters based on the vehicle travelling at a first velocity and the feedforward control command function operates according to a second set of parameters different than the first set of parameters based on the vehicle travelling at a second velocity different than the first velocity.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle equipped with an advanced driving assistance system (ADAS) that at least partially controls a steering system of the vehicle as the vehicle travels along a roadway.

FIG. 2 is a graph of estimated torque and torque measurements during operation of the steering system to guide the vehicle relative to a planned path.

FIG. 3 is a schematic diagram of a feedforward control system for modeling operation of the steering system.

FIG. 4 is a schematic diagram of the feedforward control system for modeling operation of the steering system according to a speed bucketing arrangement.

FIG. 5 is graph of torque measurements, estimated lateral vehicle position, and measured lateral vehicle position as the vehicle travels relative to a planned path having high curvature and the ADAS controls the steering system without use of the feedforward control system.

FIG. 6 is graph of torque measurements, estimated lateral vehicle position, and measured lateral vehicle position as the vehicle travels relative to the planned path having high curvature and the ADAS controls the steering system using the feedforward control system.

FIG. 7 is graph of torque measurements, estimated lateral vehicle position, and measured lateral vehicle position as the vehicle travels relative to a planned path along an S-curve of a highway and the ADAS controls the steering system without use of the feedforward control system.

FIG. 8 is graph of torque measurements, estimated lateral vehicle position, and measured lateral vehicle position as the vehicle travels relative to the planned path along the S-curve of the highway and the ADAS controls the steering system using the feedforward control system.

FIG. 9 is a flowchart of an example method of generating torque commands for the steering system of the vehicle based on the planned path for the vehicle and using the feedforward control system to model the steering system of the vehicle.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

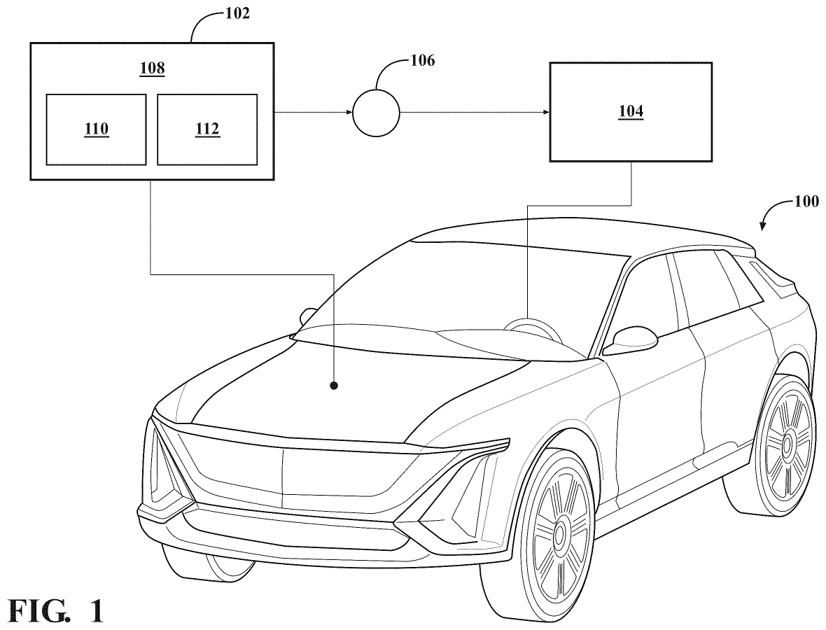

Referring now to the figures and the illustrated configurations depicted therein, a vehicle 100 is equipped with an advanced driving assistance system (ADAS) and/or an electric power steering (EPS) 102 configured to at least partially control a steering system 104 of the vehicle 100 as the vehicle 100 travels along a roadway (FIG. 1). For example, based on a planned route for the vehicle 100 to follow along the roadway, the ADAS 102 may generate torque commands 106 that, when executed by the steering system 104, cause the steering system 104 to steer the vehicle 100 toward the planned path. The steering system 104 may include an electrically operable motor coupled to a steering column of the vehicle 100 for executing the torque commands 106. As discussed further below, the ADAS 102 generates the torque commands 106 according to real-time identification of damping characteristics of the steering system 104 of the vehicle 100 using a fast-learning approach. By continuously learning the responses of the steering system 104, the ADAS 102 enables model-based feedforward control for precise tracking in steering control concerning damping characteristics of steering. As discussed further below, the system 102 may provide real-time damping of torque commands 106 generated using a feedforward control command function via updating a parameter set for the feedforward control command function based on real-time feedback signals. This enhances robustness against unmodeled uncertainties and environmental disturbances impacting transient response and ensures consistent performance across varying conditions. Moreover, the ADAS 102 reduces the proliferation of efforts and uncertainties associated with different steering systems 104 and calibrations across vehicle programs. This results in a more efficient and reliable steering system 104 for the vehicle 100 that adapts seamlessly to diverse driving scenarios and improves overall vehicle handling and safety.

The vehicle 100 includes a control module 108 including electronic circuitry and associated software and configured to operate the ADAS 102. Specifically, the control module 108 includes data processing hardware 110 and memory hardware 112 in communication with the data processing hardware 110. The memory hardware 112 stores instructions that, when executed on the data processing hardware 110, cause the data processing hardware 110 to perform operations. For example, the memory hardware 112 stores instructions for generating the torque commands 106 for the steering system 104 of the vehicle 100 based on a planned path for the vehicle 100 and using an adaptive feedforward control command function to model the steering system 104 and adjust the torque commands 106 based on feedback measured at the vehicle 100, as discussed further below.

That is, the ADAS 102 operates a feedforward control system that may use one or more sensors to detect disturbances affecting an ability of the steering system 104 to guide the vehicle 100 relative to the planned path via the torque commands 106, and the feedforward control system applies an additional input to the torque command 106 to minimize the effect of the disturbance. This requires the feedforward control system to operate a mathematical model of the steering system 104 so that the effect of the disturbances can be properly predicted. Moreover, the ADAS 102 may adjust the feedforward control system based on feedback from the steering system 104 to take into account how the feedforward control system affects the steering system 104 and how the steering system 104 may itself vary unpredictably. For example, the feedback may include a measured torque at the steering system 104, a steering angle of the steering system 104, and the like.

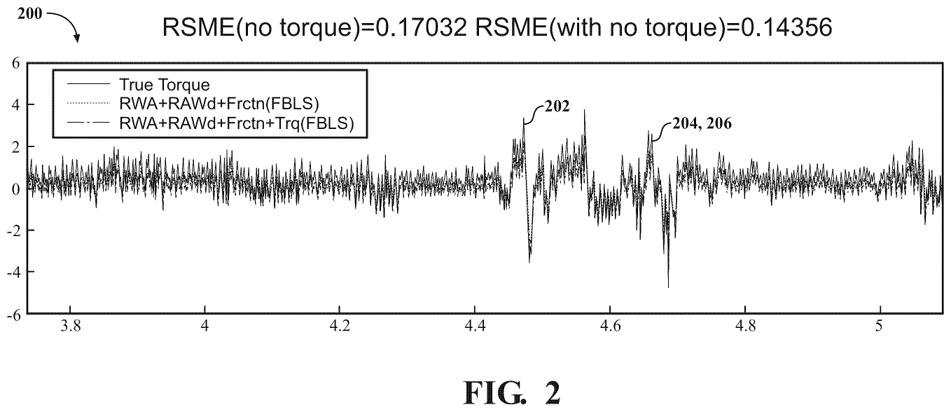

Referring to FIG. 2, graph 200 represents torque during operation of the steering system 104 that causes the vehicle 100 to follow the planned path. Line 202 represents measured torque at the steering system 104, while line 204 and line 206 represent torque estimates generated via models of the steering system 104. Accordingly, an offline model of the control command function for generating torque commands (t) may be represented as equation (1) below:

$$τ = {K}_{s ( δ , \dot{δ} , {V}_{x} )} δ + {\dot{K}}_{s ( δ , \dot{δ} , {V}_{x} )} {δ}_{+ d} + {K}_{sd ( δ , \dot{δ} , {V}_{x} )} \dot{δ} + {K}_{t ( δ , \dot{δ} , {V}_{x} )} {τ}_{- d} + {K}_{c 0 ( δ , \dot{δ} , {V}_{x} )} sgn ( \dot{δ} ) - {K}_{c 0 ( δ , \dot{δ} , {V}_{x} )} {\dot{δ}}^{\frac{1}{2}} sgn ( \dot{δ} ) \qquad ( 1 )$$

where (K_{s(δ,\dot{δ},v}_{ₓ}₎), (K_{sd(δ,\dot{δ},v}_{ₓ}₎), (KK_{t(δ,\dot{δ},v}_{ₓ}₎), and (KK_{c0(δ,\dot{δ},v}_{ₓ}₎) represent unknown but observable or learnable parameters representative of a model of the steering system 104 that are learned via the feedforward control system and that may affect a ratio between torque (τ) at the steering system 104 and steering angle (δ) of the steering system 104. As discussed further below, these unknown but observable parameters may be referred to herein collectively as a set of parameters (X). Moreover, the steering angle (δ) and its derivatives, measured torque at the steering system 104 (and other inputs or states of the vehicle) may be referred to herein collectively as states or inputs (u).

A linear feedforward control command function for generating torque commands (t) may be represented as equation (2) below:

$$τ = {K}_{s} δ + {K}_{sd} \dot{δ} + {K}_{sdd} \ddot{δ} + {K}_{t} \dot{τ} + {τ}_{f} ( t ) \qquad ( 2 )$$

In Laplace domain, this may be represented as equation (3) below:

$$T ( s ) = {K}_{s} Δ ( s ) + {K}_{sd} Δ ( s ) S + {K}_{sdd} Δ ( s ) {S}^{2} + {K}_{t} T ( s ) S + {T}_{F} ( S ) \qquad ( 3 )$$

Thus, the feedforward control command may be represented as equation (4) below:

$$\frac{T ( s )}{Δ ( s )} = \frac{{K}_{s} + {K}_{sd} S + {K}_{sdd} {S}^{2}}{1 - {K}_{t} S} \qquad ( 4 )$$

Because the feedforward control command of equation (4) implies a feedbacked command, it may be susceptible to having a right hand plane (RHP) pole depending on the learn value of (Kₜ). That is, the feedforward control command may become increasingly unstable over time. Accordingly, the torque dynamics are either not to be accounted for, or stability of the feedforward control command may be ensured by limiting (Kₜ). Some model perturbation may be exchanged for stability in the feedforward command function by using a learned transfer function represented as equation (5) below:

$$\frac{T ( s )}{Δ ( s )} = \frac{{K}_{s} + {K}_{sd} S + {K}_{sdd} {S}^{2}}{( 1 - \sqrt{{K}_{t}} {S}^{0.5} ) ( 1 + \sqrt{{K}_{t}} {S}^{0.5} )} \qquad ( 5 )$$

where the fractional order term (1−\sqrt{KₜS}^{0.5}) is ignored.

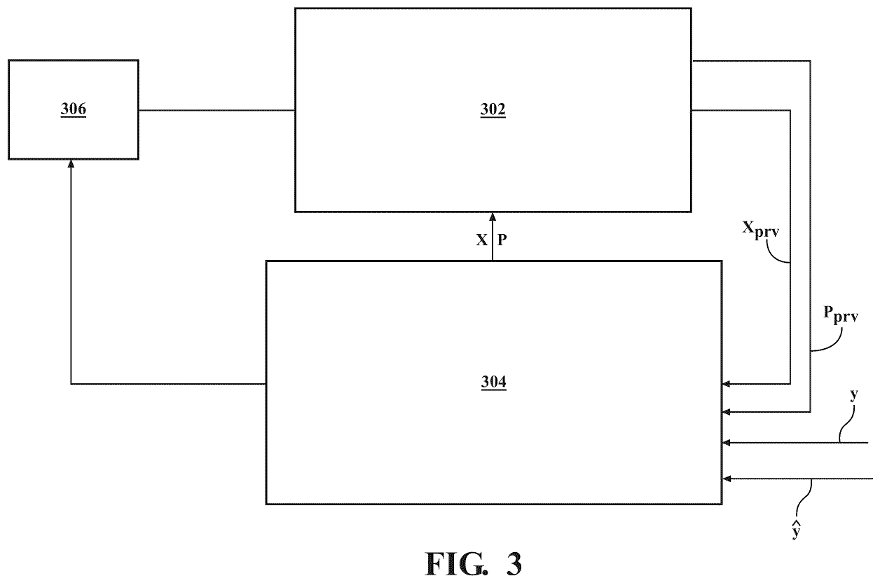

Referring to FIG. 3, the ADAS 102 operates an online model learning algorithm or system 300 to update the set of parameters (X) of the learned transfer function during operation of the vehicle 100. That is, as the ADAS 102 operates the steering system 104 to execute torque commands 106 to cause the steering system 104 to guide the vehicle 100 relative to the planned path, the ADAS 102 may adjust the torque commands 106 based on the model of the steering system 104 and the ADAS 102 may update or adjust the parameters (X) of the modeled steering system based on measured feedback from the vehicle 100 representative of performance of the steering system 104. Subsequent torque commands 106 may be generated using the feedforward control command function modeling the steering system 104 having the updated or adjusted parameters (X).

A model updating module 302 of the system 300 may determine an estimated torque output (y) based on a current set of parameters (x) of the modeled steering system 104 and the set of inputs or states (u) of the vehicle 100. The estimated torque (y) may be represented as equation (6) below:

$$y = u * x \qquad ( 6 )$$

The model updating module 302 may further determine a learning gain (G) represented as equation (7) below:

$$G = {p}_{prv} * u / ( λ + ( {p}_{prv} * {u}^{2} ) ) \qquad ( 7 )$$

where (p_{Prv}) represents a previous covariance of the parameters (X) and (λ) represents a learning factor. A new covariance (p_{new}) may be determined according to equation (8) below:

$${p}_{new} = ( 1 / λ ) * ( {p}_{prv} - ( {p}_{prv} * u * G ) ) \qquad ( 8 )$$

Based on the learning gain (G), the estimated torque (y), states (u) of the vehicle 100, and a previous set of parameters (Xₚᵣᵥ), a new set of parameters (X_{new}) for updating the model may be determined according to equation (9) below:

$${X}_{new} = {X}_{prv} + G ( ( y - u ) * {X}_{prv} ) \qquad ( 9 )$$

Based on the previous set of parameters (Xₚᵣᵥ) and the previous covariance (pₚᵣᵥ) received from the model updating module 302, and based on the estimated torque (y) and a measured torque (ŷ), an evaluation module 304 of the system 300 determines one or more failure modes. In determining one or more failure modes, the evaluation module 304 may instruct a modular state order module 306 to enable active states from a selection of viable states of the model (e.g., [δ, \dot{δ}, \ddot{δ}, \dot{τ}]). For example, in response to determining that the current covariance (p) is between a minimum covariance (pₘᵢₙ) and a maximum covariance (pₘₐₓ), the system 300 may reduce order based on violating the diagonal's index. Based on determining that the covariant rate (\dot{p}) is less than or equal to a maximum covariance rate (\dot{p}ₘₐₓ), the system 300 may halt the learn process and freeze the previous set of parameters (Xₚᵣᵥ). Responsive to determining that the current set of parameters (X) are between a minimum parameter value Xₘᵢₙ and a maximum parameter value Xₘₐₓ, the system 300 may halt the learn process and halt the covariance update. Based on the parameter rate of change (\dot{X}) being less than or equal to a maximum parameter rate limit (\dot{X}ₘₐₓ), the system 300 may continue the learn process and halt the covariance update. In response to determining that the estimated torque (y) 100 minus the measured torque (ŷ) is less than a limit (∈), the system 300 may reduce the order based on violating the diagonal. When curvature of the vehicle's path (ρ) is greater than a minimum curvature (ρₘᵢₙ) as a function of longitudinal velocity (Vₓ) of the vehicle, the system 300 may continue the learn process and refractor off-diagonal for a faster learn process since steering wheel angle is more active in these scenarios. The evaluation module 304 may provide the set of parameters (X) and the covariance (p) to the updating module 302.

Thus, the system 300 may model the steering system 104 by comparing the output torque (y) from the steering model versus measured torque (ŷ). This may instruct the model how steering angle (δ) is related to torque (τ) at the vehicle 100. In order to improve the accuracy of the model, the set of parameters (X) are learned and, once the parameters (X) are obtained, the feedforward torque command 106 is calculated by substituting the parameters (X) and the steering angle command into the steering system model equation.

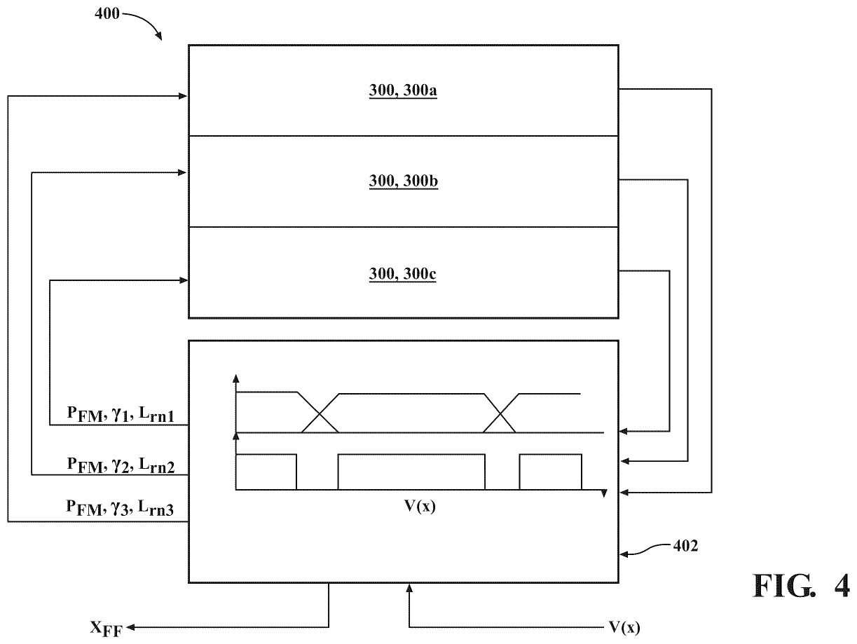

In some examples, the ADAS 102 may operate the online model learning algorithm or system 300 according to a speed bucketing operation 400 (FIG. 4). That is, the ADAS 102 may generate torque commands 106 using the feedforward control command function having different sets of parameters (X) based on the velocity (Vₓ) of the vehicle 100. Put another way, the feedforward control command may model the steering system 104 differently based on the velocity (Vₓ) of the vehicle 100. Although the illustrated example shows the speed bucketing operation 400 generating sets of parameters (X) for three different velocity ranges of the vehicle 100, it should be understood that the speed bucketing operation 400 may generate sets of parameters (X) for any suitable number of different velocity ranges of the vehicle 100, where each set of parameters (X) may guide the model of the feedforward control command function within a defined range of velocities. Further, the velocity ranges may at least partially overlap to allow for smoother control of the steering system 104 at speeds that fall close to the range limits.

As shown in FIG. 4, a bucketing module 402 may operate instances of the model learning system 300, such as a first instance 300, 300a, a second instance 300, 300b, and a third instance 300, 300c, for respective ranges of velocities (Vₓ) of the vehicle 100. Based on the current velocity (Vₓ) of the vehicle 100, the bucketing module 402 outputs the set of parameters (X_{FF}) for the model of the steering system 104 used in determining the torque commands 106. For velocities (Vₓ) that overlap adjacent ranges, the bucketing module 402 may weight parameter sets (X_{FF}) for the respective ranges. For each instance of the model learning system 300, the bucketing module may provide covariance for failure mode consideration (P_{FM}), bucket activation ratio (γ_{1,2,3}), and enablement flag for buckets (Lrn_{1,2,3}), such that for a respective velocity range corresponding to one of the instances of the model learning system 300, the parameter set (X_{FF}) may be determined according to equation (10) below:

$${X}_{FF} = \frac{\sum {γ}_{i} {X}_{i}}{\sum {γ}_{t}} \qquad ( 10 )$$

and covariance (P_{FM}) may be determined according to equation (11) below:

$${P}_{FM} = \frac{\sum {γ}_{i} {P}_{i}}{\sum {γ}_{t}} \qquad ( 11 )$$

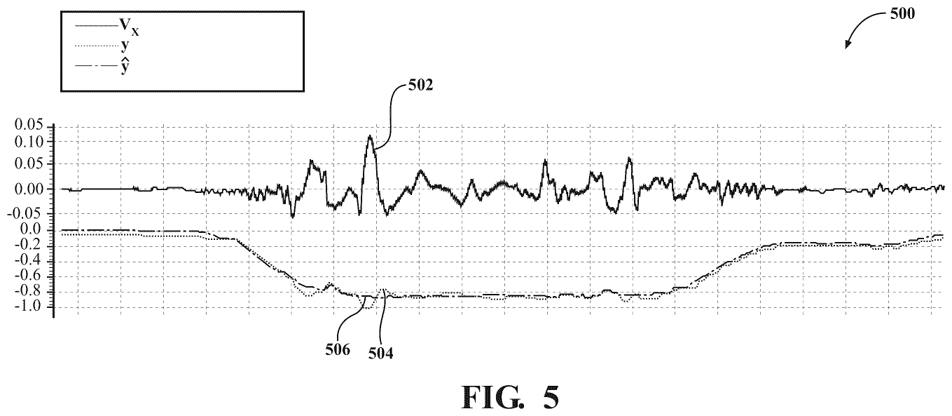

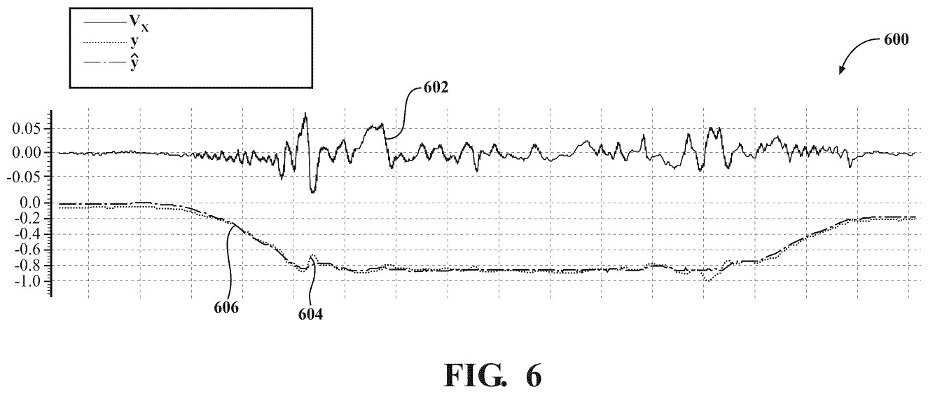

FIG. 5 includes a chart 500 representing lateral velocity of the vehicle 502, generated torque commands 504, and actual or measured torque 506 as the vehicle travels relative to the planned path and the ADAS 102 controls the steering system 104 without use of the feedforward control system 300. FIG. 6 includes a chart 600 representing lateral velocity of the vehicle 602, generated torque commands 604, and actual or measured torque 606 as the vehicle travels relative to the planned path and the ADAS 102 controls the steering system 104 using the feedforward control system 300. The planned path represented in FIGS. 5 and 6 includes high curvature. As shown in FIGS. 5 and 6, the feedforward control system 300 generates torque commands 106 that result in smoother steering with fewer oscillations. That is, the generated torque command line 604 may correspond more closely to and vary less dramatically from the measured torque line 606 (i.e., less difference, fewer oscillations, smaller peaks, etc.) than the measured torque line 506 relative to the generated torque command line 504.

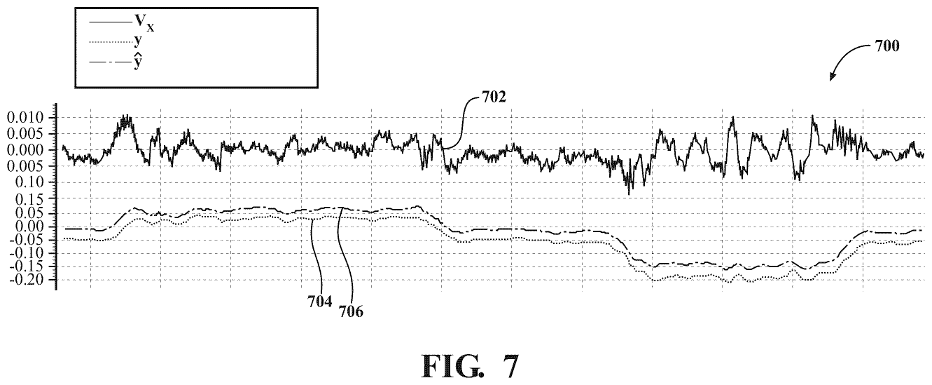

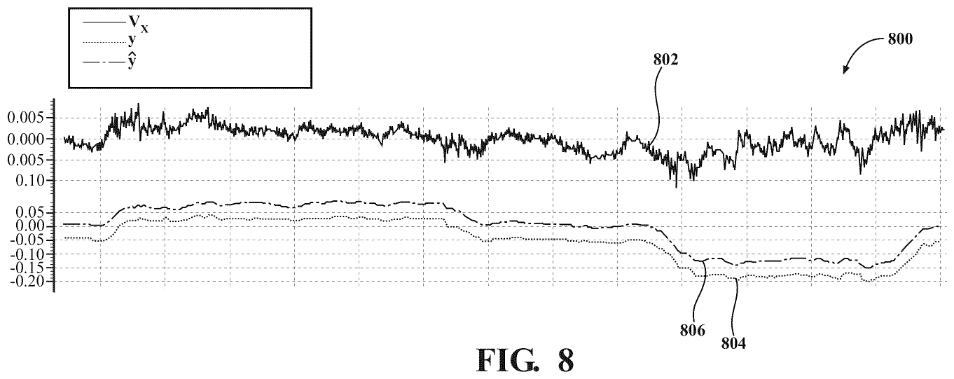

Similarly, FIG. 7 includes a chart 700 representing lateral velocity of the vehicle 702, generated torque commands 704, and actual or measured torque 706 as the vehicle travels relative to the planned path and the ADAS 102 controls the steering system 104 without use of the feedforward control system 300. FIG. 8 includes a chart 800 representing lateral velocity of the vehicle 802, generated torque commands 804, and actual or measured torque 806 as the vehicle travels relative to the planned path and the ADAS 102 controls the steering system 104 using the feedforward control system 300. The planned path represented in FIGS. 7 and 8 is along an S-curve of a highway or high-speed road. As shown in FIGS. 7 and 8, the feedforward control system 300 generates torque commands 106 that result in smoother steering with fewer oscillations. That is, the generated torque command line 804 may correspond more closely to and vary less dramatically from the measured torque line 806 (i.e., less difference, fewer oscillations, smaller peaks, etc.) than the measured torque line 706 relative to the generated torque command line 704.

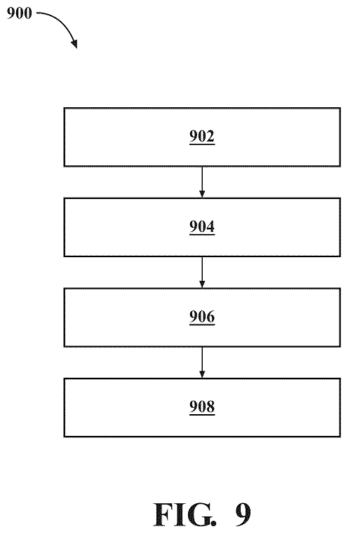

FIG. 9 provides a flowchart for an example method 900 for generating torque commands 106 for the steering system 104 of the vehicle 100 based on the planned path for the vehicle 100 and using the feedforward control system 300 to model the steering system 104 of the vehicle 100. The control module 108 may perform operations for the method 900. At operation 902, the method 900 includes operating a motor of the steering system 104 of the vehicle 100 as the vehicle travels relative to the planned path to execute a torque command 106. The torque command 106 causes the steering system 104 of the vehicle 100 to guide the vehicle 100 toward the planned path. Responsive to operating the motor to execute the torque command 106, and based on measured feedback from the vehicle 100, the method 900 at operation 904 includes adjusting the parameter set of the feedforward control command function 300. Responsive to adjusting the parameter set of the feedforward control command function 300, the method 900 at operation 906 includes generating another torque command using the feedforward control command function 300 having the updated or adjusted parameter set. At operation 908, the method 900 includes operating the motor of the steering system 104 to execute the torque command 106 based on the updated or adjusted parameter set to cause the steering system 104 to guide the vehicle 100 toward the planned path.

Because the feedforward control system 300 adjusts the model of the steering system 104 as the vehicle 100 travels along the road, the ADAS 102 may learn parameters for the feedforward control system 300 of the individual vehicle across different vehicle platforms. Moreover, the algorithm 300 may learn parameters for different speed buckets to achieve more accurate control throughout the range of speeds of the vehicle 100 and the speed buckets may overlap to provide smoother transition of steering control between speed buckets.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed on data processing hardware causes the data processing hardware to perform operations comprising:
operating a motor of a steering system of a vehicle as the vehicle travels relative to a planned path to execute a first torque command, the first torque command causing the steering system of the vehicle to guide the vehicle toward the planned path;
responsive to operating the motor to execute the first torque command, and based on measured feedback from the vehicle, adjusting a parameter set of a feedforward control command function;
responsive to adjusting the parameter set of the feedforward control command function, generating a second torque command using the feedforward control command function having the adjusted parameter set; and
operating the motor of the steering system to execute the second torque command to cause the steering system of the vehicle to guide the vehicle toward the planned path.

2. The method of claim 1, wherein the measured feedback includes a measured torque at the steering system of the vehicle.

3. The method of claim 1, wherein the measured feedback includes a determined steering angle of the steering system of the vehicle.

4. The method of claim 1, wherein the first torque command is generated using the feedforward control command function prior to adjusting the parameter set.

5. The method of claim 1, wherein the feedforward control command function includes a learned model of the steering system of the vehicle.

6. The method of claim 5, wherein adjusting the parameter set of the feedforward control command function adjusts the learned model of the steering system of the vehicle.

7. The method of claim 1, wherein the feedforward control command function operates according to a first set of parameters based on the vehicle travelling at a first velocity and the feedforward control command function operates according to a second set of parameters different than the first set of parameters based on the vehicle travelling at a second velocity different than the first velocity.

8. A system comprising:
memory hardware storing instructions that, when executed on data processing hardware in communication with the memory hardware, cause the data processing hardware to perform operations comprising:
operating a motor of a steering system of a vehicle as the vehicle travels relative to a planned path to execute a first torque command, the first torque command causing the steering system of the vehicle to guide the vehicle toward the planned path;
responsive to operating the motor to execute the first torque command, and based on measured feedback from the vehicle, adjusting a parameter set of a feedforward control command function;
responsive to adjusting the parameter set of the feedforward control command function, generating a second torque command using the feedforward control command function having the adjusted parameter set; and
operating the motor of the steering system to execute the second torque command to cause the steering system of the vehicle to guide the vehicle toward the planned path.

9. The system of claim 8, wherein the measured feedback includes a measured torque at the steering system of the vehicle.

10. The system of claim 8, wherein the measured feedback includes a determined steering angle of the steering system of the vehicle.

11. The system of claim 8, wherein the first torque command is generated using the feedforward control command function prior to adjusting the parameter set.

12. The system of claim 8, wherein the feedforward control command function includes a learned model of the steering system of the vehicle.

13. The system of claim 12, wherein adjusting the parameter set of the feedforward control command function adjusts the learned model of the steering system of the vehicle.

14. The system of claim 8, wherein the feedforward control command function operates according to a first set of parameters based on the vehicle travelling at a first velocity and the feedforward control command function operates according to a second set of parameters different than the first set of parameters based on the vehicle travelling at a second velocity different than the first velocity.

15. A vehicle comprising:
a steering system including a motor; and
memory hardware storing instructions that, when executed on data processing hardware in communication with the memory hardware, cause the data processing hardware to perform operations comprising:
operating the motor of the steering system as the vehicle travels relative to a planned path to execute a first torque command, the first torque command causing the steering system of the vehicle to guide the vehicle toward the planned path;
responsive to operating the motor to execute the first torque command, and based on measured feedback from the vehicle, adjusting a parameter set of a feedforward control command function;
responsive to adjusting the parameter set of the feedforward control command function, generating a second torque command using the feedforward control command function having the adjusted parameter set; and
operating the motor of the steering system to execute the second torque command to cause the steering system of the vehicle to guide the vehicle toward the planned path.

16. The vehicle of claim 15, wherein the measured feedback includes a measured torque at the steering system of the vehicle.

17. The vehicle of claim 15, wherein the measured feedback includes a determined steering angle of the steering system of the vehicle.

18. The vehicle of claim 15, wherein the first torque command is generated using the feedforward control command function prior to adjusting the parameter set.

19. The vehicle of claim 15, wherein the feedforward control command function includes a learned model of the steering system of the vehicle.

20. The vehicle of claim 15, wherein the feedforward control command function operates according to a first set of parameters based on the vehicle travelling at a first velocity and the feedforward control command function operates according to a second set of parameters different than the first set of parameters based on the vehicle travelling at a second velocity different than the first velocity.
